(19) United States
(12) Patent Application Publication
(10) Pub. No.: US 2026/0283143 A1
(43) Pub. Date: Sep. 24, 2026

(54) TREE STAND MOUNTING DEVICE AND METHOD OF MOUNTING A TREE STAND TO A TREE

(71) Applicant: Jesse Weygand, Seneca, IL (US)

(72) Inventor: Jesse Weygand, Seneca, IL (US)

(21) Appl. No.: 19/570,387

(22) Filed: Mar. 18, 2026

Related U.S. Application Data
(60) Provisional application No. 63/775,409, filed on Mar. 21, 2025.

(51) Int. Cl. A01M 31/02

(52) U.S. Cl. CPC A01M 31/02

(57) ABSTRACT

The present disclosure relates to tree stands or blinds positioned at a selected height within trees for surveillance. More specifically, the present disclosure relates to an adjustable tree stand mounting device which is adjustable into a plurality of positions and useful for mounting and aligning a tree stand at a determined height onto a variety of trees regardless of the tree's surface or configuration. A method of mounting a tree stand to a surface of a tree is also provided.

### TECHNICAL FIELD

The present disclosure relates to a mounting device for securing tree stands or blinds onto or into a tree or another structure at a selected height to provide an above ground surveillance surface. More specifically, the present disclosure relates to a tree stand mounting device which is adjustable in a plurality of positions for mounting, aligning and leveling a tree stand onto a variety of trees regardless of the tree's surface or configuration. The disclosure also relates to a method of mounting a tree stand to a tree or other surface in a level position in relation to the tree.

### BACKGROUND

Tree stands also known as blinds or deer stands are generally platform structures hunters secure onto a tree at a given height to provide an above-ground vantage point for surveillance of the surrounding area. Typical tree stands are generally chair-like structures, with a seat and foot platform, which is secured to a tree at a set height using a variety of straps.

Properly securing a tree stand generally includes wrapping a strap or multiple straps from the tree stand around the tree trunk. Additionally, it is desirable not only to securely fasten the tree stand to the tree, but to also make the seat and platform of the tree stand as level as possible so the user can sit comfortably for an extended period of time. However, because most tree trunks are not straight and can vary in width and diameter, properly securing a tree stand to the tree in an ideal level position is often difficult. Additionally, the strap alone may not be ideal for securely fastening the tree stand to the tree.

A need, therefore, exists for an improved tree stand mounting device for securing and supporting a tree stand to a tree. Specifically, a need exists for an improved tree stand mounting device that can securely mount a tree stand in a level position regardless of the configuration and/or surface structure of the tree.

A need further exists for an improved tree stand mounting device which permits the user to mount a tree stand in any ideal location and height not dependent on the configuration of a particular tree.

A need further exists for an improved tree stand mounting device for securing a tree stand wherein the tree stand mounting device is adjustable for leveling the tree stand in any desired tree.

A need further exists for an improved tree stand mounting device for mounting and leveling a tree stand into any tree regardless of whether the tree is straight, has a knot and/or an uneven surface, or includes any other irregularities that typically make leveling a tree stand difficult.

A need also exists for an improved tree stand mounting device that is fully adjustable to accommodate small or large diameter trees and trees with any configuration.

### SUMMARY

The present disclosure relates generally to tree stands used for positioning within a tree at a height useful for surveillance of an area above ground, typically for various outdoor activities including bird/animal watching and surveillance and hunting. Tree stands can include open platform surfaces, frequently including a seat and a footrest, and/or a fully or partially enclosed platform. More specifically, the present disclosure relates to a tree stand mounting device that is adjustable and therefore useful for mounting a tree stand in a level and secure position onto a variety of trees regardless of a tree's configuration. Another advantage of the present tree stand mounting device is that it does not limit the user to mounting the tree stand based on tree configuration but rather permits the user to choose an ideal location and/or height regardless of a tree's configuration.

To this end, in an embodiment of the present disclosure, a tree stand mounting device useful for mounting a tree stand onto a tree is provided. The device comprises a body having center section with a first or top end and a second or bottom opposing end, wherein the device includes a plurality of adjustment mechanisms positioned at various locations along the body of the mounting device. The adjustment mechanisms are configured to be independently adjusted to move the body of the mounting device into numerous positions along a tree surface to secure and level the mounting device against the surface of the tree. The mounting device then serves as a base for mounting and leveling a tree stand to a particular tree.

In another embodiment, a method of mounting a tree stand to a surface of a tree, is provided. The method comprises the steps of providing a tree stand mounting device comprising a body having center section, the center section having a first end and a second opposing end and, a plurality of adjustment mechanisms each adjustment mechanism positioned at a separate location along the body of the mounting device, securing the tree stand mounting device to the surface of the tree, adjusting the plurality of adjustment mechanism to align the body with the surface of the tree, leveling the body of the tree stand mounting device relative to the surface of the tree and securing the tree stand to the tree stand mounting device.

It is, therefore, an advantage and objective of the present disclosure to provide a tree stand mounting device that is adjustable and therefore useful for mounting a tree stand in a level and secure position onto a variety of trees regardless of a tree's configuration, including pitch of a tree. The tree stand mounting device is capable of movement in a variety of directions in relation to the surface of the tree, thereby providing a level mounting surface for a tree stand.

It is another advantage and objective of the present disclosure to provide a method for mounting a tree stand to a surface of a tree, utilizing a tree stand mounting device, which is adjustable to provide a level mounting surface for tree stand regardless of the configuration of the tree or tree surface.

Additional features and advantages of the present disclosure are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, reference numerals refer to the same or similar elements.

FIG. 1 illustrates an embodiment of a tree stand mounting device according to the present disclosure in use on a tree;

FIG. 2 illustrates an embodiment of a tree stand mounting device with a two-way adjustable mechanism arrangement according to the present disclosure;

FIG. 3 illustrates a front view of a tree stand mounting device of FIG. 1 according to the present disclosure;

FIG. 4 illustrates a rear view of a tree stand mounting device of FIG. 1 according to the present disclosure;

FIG. 5 illustrates a close-up view of a first adjustment mechanism of the tree stand mounting device according to the present disclosure;

FIG. 6 illustrates a close-up view of a second adjustment mechanism of the tree stand mounting device according to the present disclosure;

FIG. 7 illustrates another embodiment of a tree stand mounting device having four-way adjustable mechanism arrangement according to the present disclosure;

FIG. 8 illustrates a rear view of a tree stand mounting device of FIG. 7 according to the present disclosure;

FIG. 9 illustrate the tree stand mounting device of FIG. 7 secured to a surface;

FIG. 10 illustrates an embodiment of the tree stand mounting device of the present disclosure with a tree stand attached to the device.

### DETAILED DESCRIPTION

The present disclosure relates generally to tree stands used for above ground observation activities, including bird/animal watching and hunting. More specifically, the present disclosure relates to a tree stand mounting device that is adjustable and therefore useful for mounting a tree stand in a level and secure position onto a variety of trees regardless of a tree's surface and/or configuration, including pitch of the tree. The present disclosure provides various embodiments of the tree stand mounting device, including embodiments wherein the mounting device is capable of movement in multiple directions, thereby providing numerous options for securing and leveling a tree stand in a chosen tree or other mounting structure regardless of the confirmation of the tree or tree surface. The present disclosure also relates to a method of mounting a tree stand to a surface of a tree utilizing the adjustable tree stand mounting device.

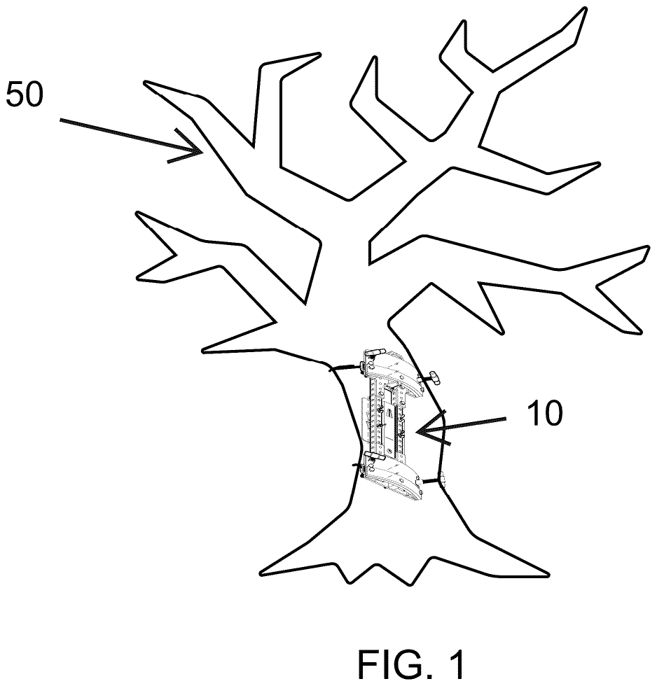

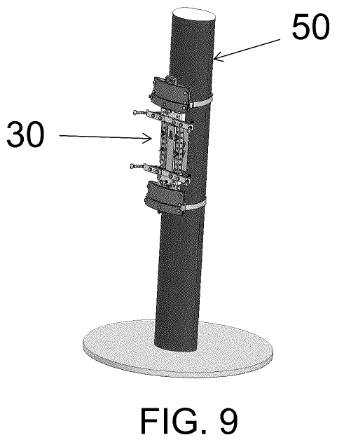

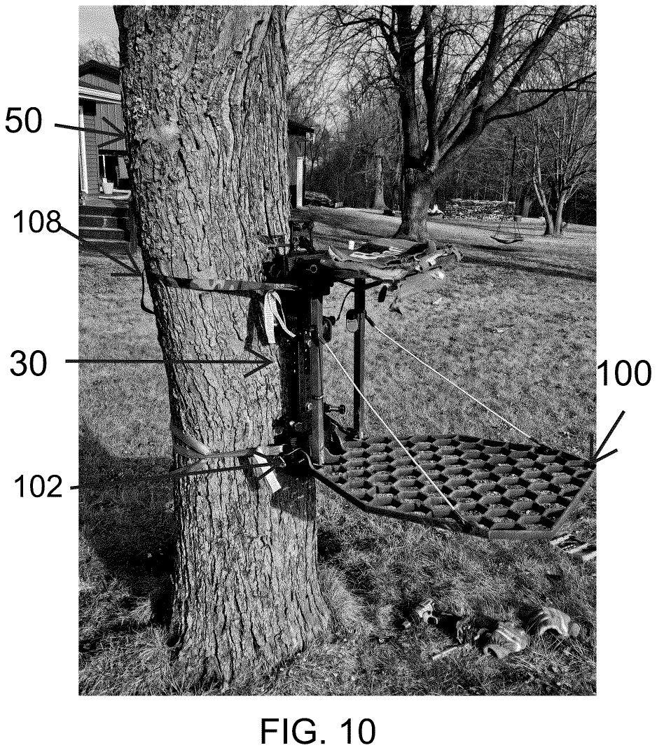

Now referring to the figures, wherein like numerals refer to like parts, FIGS. 1-9 illustrates embodiments and components of a tree stand mounting device and the tree stand mounting device in use on a tree, according to the present disclosure. The tree stand mounting device provides multiple adjustment mechanisms, which permits the mounting device to be positioned and secured to any tree configuration, including an uneven surface, thereby providing a level position for the tree stand.

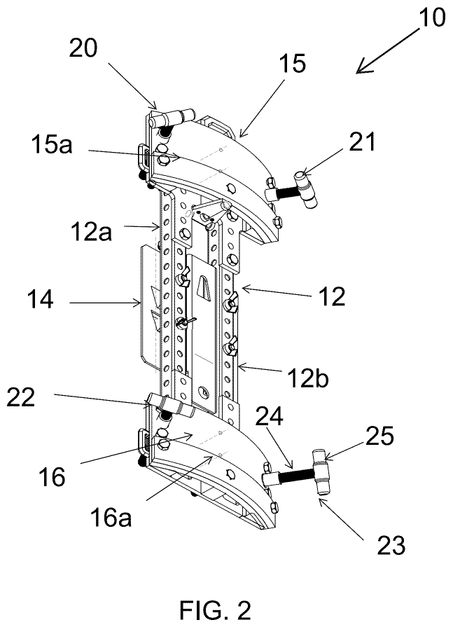

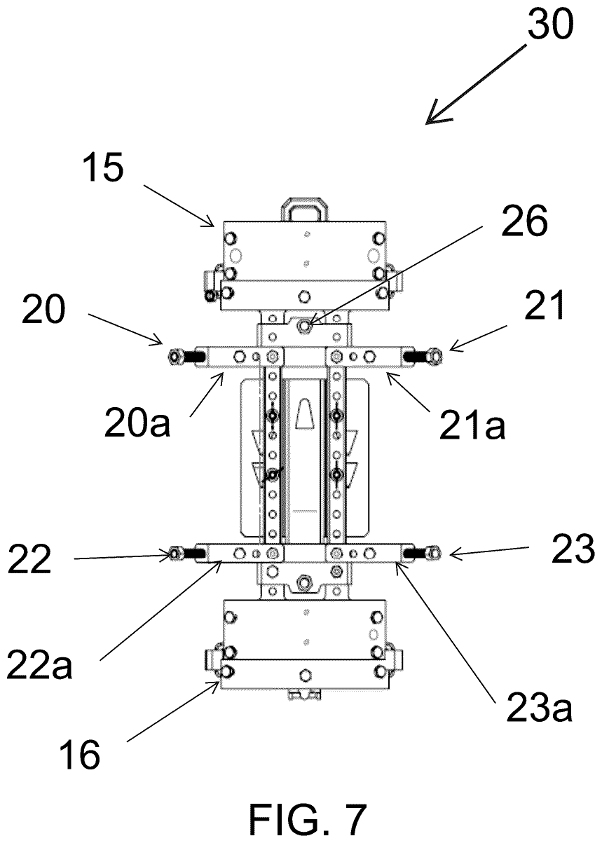

FIG. 1 illustrates an embodiment of a tree stand mounting device 10 attached to a tree. FIGS. 2-5 illustrate an embodiment of a tree stand mounting device 10, which includes a two-way adjustable mechanism arrangement. The two-way adjustable mechanism arrangement permits forward and back positioning movement of the mounting device in relation to the surface of a mounting structure, such as a tree. FIGS. 7-9 illustrate a second embodiment of a tree stand mounting device 30, which includes a four-way adjustable mechanism arrangement. The four-way adjustable mechanism permits side-to-side, as well as forward and back positioning movement of the mounting device in relation to the surface of a mounting structure, such as a tree. The components and features described herein are applicable to both the two-way adjustable embodiment 10 of the tree stand mounting device and the four-way adjustable embodiment 30 of the tree stand mounting device.

Each embodiment of the tree stand mounting device 10, 30 provides numerous options to adjust the body of the tree stand mounting device in relation to the surface of a tree regardless of whether the surface structure is smooth or uneven. An advantage of the present tree stand mounting device 10, 30 is that it is useful for mounting a tree stand in a level position to any type of uneven mounting surface or tree 50 including crooked trees, trees with knots, and trees without a good flat spot or surface. FIG. 10 illustrates an embodiment of the present tree stand mounting device 30 secured to a tree 50 with a tree stand 100 attached thereto.

Referring now to FIGS. 2-4, there is shown an embodiment of the tree stand mounting device 10 with a two-way adjustable mechanism. The tree stand mounting device 10 includes a body 11 having an elongated center section 12 formed from two parallel rails 12a, 12b. Each rail 12a, 12b includes a plurality of openings 13 for receiving fasteners 13a for connecting the center section to a support anchor 14. The support anchor 14 can be used to secure the tree stand mounting device 10 to a tree surface using known fasteners.

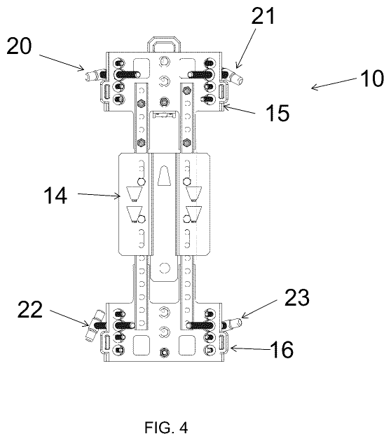

The tree stand mounting device 10 includes a top mounting pad 15 and a bottom mounting pad 16. The mounting pads 15, 16 are secured separately to opposing ends of the center section 12 using known fasteners, such as bolts or screws. The top mounting pad 15 is located at a top end of the center section 12, while the bottom mounting pad 16 is located at an opposing bottom end of the center section. The mounting pads 15, 16 can be constructed from a rubber or flexible material. As shown in FIGS. 2 and 4, the top mounting pad 15 sits horizontally at the top of the center section 12, while the bottom mounting pad 16 sits horizontally at the bottom of the center section.

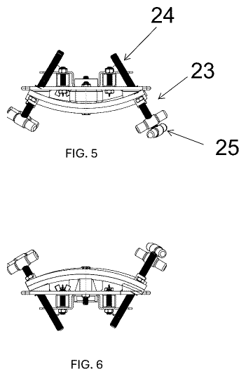

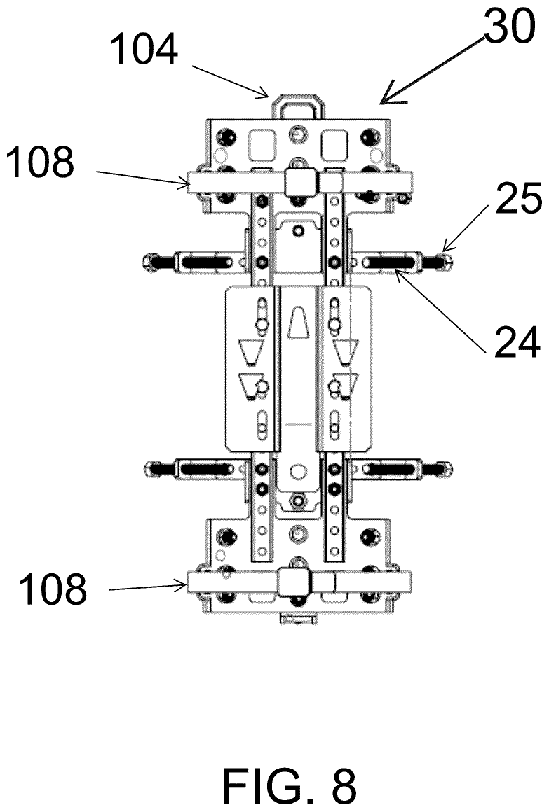

Each mounting pad 15, 16 has a length extending across and greater than the width of the center section 12. The mounting pads 15, 16 are used to support a tree stand 100 after it is secured to the mounting device 10, 30 (FIG. 8). As shown in FIGS. 5 and 6, the mounting pads 15, 16 include an outward curved configuration, which provides a surface for supporting the tree stand 100 outward from the body 11 of the mounting device 10 when the tree stand is positioned on the mounting device 10.

The mounting pads 15,16 may be constructed from a rubber or pliable material to allow notches on the tree stand 100 to sink into the respective mounting pad, thereby securing the tree stand against the mounting device 10. Because the positioning of notches on tree stands 100 can vary with different brands of tree stands, the mounting pads 15, 16 and particularly the top mounting pad 15, can be adjusted up and down along the parallel rails 12a, 12b of the center section 12 to accommodate the positioning of the notches on a particular stand.

Additionally, the top mounting pad 15 includes a ledge 15a extending outward from the surface of the support pad. The ledge 15a is configured to receive a top notch on the tree stand 100, which enables the tree stand to sit level on the tree stand mounting device 10. The bottom mounting pad 16 also includes a ledge 16a extending outward from the surface support pad 16. The ledge 16a is configured for receiving a bottom notch on the tree stand 100 so that the tree stand sits level on the mounting device 10. The tree stand 100 can be further secured to the selected tree using a plurality of straps wrapped around the tree. The ledges 15a,16a also provides support so that the tree stand 100 does not slip off the mounting device 10. Mounting pads 15, 16 are also easily removed and replaceable as needed, without having to replace the entire tree stand mounting device 10.

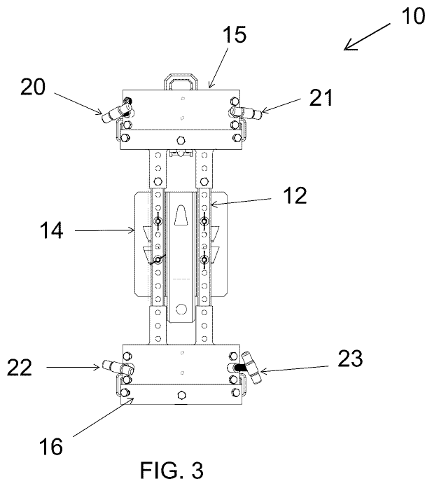

A unique feature of the present tree stand mounting device 10, 30 is its adjustability in various directions, which ensures that the tree stand 100 mounted onto the mounting device is secure and level regardless of the configuration or surface of the selected tree. Adjustability is accomplished through an adjustment mechanism arrangement, which can be either a two-way adjustment mechanism (FIGS. 2-4) or a four-way adjustment mechanism (FIGS. 7-9). In the two-way adjustment mounting device 10, the adjustment mechanisms includes a first adjustment mechanism 20 and second adjustment mechanism 21 positioned near or at the top mounting pad 15, and a third adjustment mechanism 22 and fourth adjustment mechanism 23 positioned near or at the bottom mounting pad 16. The adjustment mechanisms are positioned near opposing sides of each of the top mounting pad 15 and bottom mounting pad 16 (FIGS. 2, 3).

Similarly, as shown in FIGS. 7 and 8, the four-way adjustment mounting device 30 also utilizes a plurality of adjustment mechanisms 20, 21, 22, 23 to align the body of the tree mounting device 30 to a tree surface. The first adjustment mechanism 20 and second adjustment mechanism 21 are positioned along the center section 12 near the top mounting pad 15 of the device. The third adjustment mechanism 22 and fourth adjustment mechanism 23 are also positioned along the center section 12 of the device 30 near to the bottom mounting pad 16 of the device.

On the four-way adjustment mounting device 30, the first adjustment mechanism 20 and second adjustment mechanism 21 are positioned on separate arms 20a, 21a, which extend outward from and perpendicular to the center section 12, forming a “T” shape across a width of the center section 12 of the mounting device 30. Similarly, the third adjustment mechanism 22 and fourth adjustment mechanism 23 are positioned on separate arms 22a, 23a, which extend outward from and perpendicular to the center section 12 forming a “T” shape across a width of the center section 12 of the mounting device 30 (FIGS. 7 and 8).

The adjustment mechanisms 20, 21, 22, 23 of the tree stand mounting devices 10, 30 each includes a threaded rod 24 with a handle 25 on the end of the rod. The threaded rod 24 passes through corresponding threaded openings 15b within the top mounting pad 15 and openings 16b within the bottom mounting pad 15, extending the threaded rod behind the pads and center section 12 in the two-way tree mounting device 10 (FIGS. 4-6). In the four-way mounting device 30, each threaded road 24 passes through corresponding openings 20b, 21b, 22b, 23b in the respective arms 20a, 21a, 22a, 23a of the mounting device 30. Each threaded rod 24 is configured to engage the surface of a tree for adjusting the body of the tree mounting device 10, 30 in relation to the surface of the tree.

Initially, the tree stand mounting device 10, 30 is attached to a selected tree 50 using the anchor plate 14 and fasteners 13a through the openings 13 in the rails 12a, 12b of the center section 12 (FIG. 1). The adjustability of the present mounting device 10, 30 is accomplished through each of the adjustment mechanisms 20, 21, 22, 23 and their plurality of adjustable rods 24, which are used to position the mounting device in relation to the surface of a tree 50 as previously described.

Utilizing the handle 25, each threaded rod 24 of the respective adjustment mechanisms 20, 21, 22, 23 are individually rotated clockwise or counterclockwise which moves the threaded rod 24 back and forth within respective openings for engagement with the tree surface. Rotation of the thread rods 24 enables moving the mounting device 10 in multiple directions, including side-to-side and forward and back in relation to the tree surface, to either move the mounting device closer to and/or away from the tree surface effectively aligning the mounting device 10 to the tree surface regardless of the configuration of the tree and/or tree surface. The threaded rods 24 also engage the surface of the tree to further secure the mounting device to the tree surface.

In the four-way adjustable embodiment of the mounting device 30, adjustment mechanism 20,21, 22, 23 are adjustable to position the mounting device in a side-to-side motion. The four-way adjustability of this mounting device 30 is further accomplished through addition of at least one or more adjustable screws 26, which are located within the center section 12. As shown in FIG. 7 the center adjustable screws 26 are positioned perpendicular to and within the center section 12, providing forward and back adjustability to the mounting device 30, when the screws 26 are rotated toward and away from the surface of the tree.

Regardless of which mounting device is utilized, the two-way adjustable mounting device 10 or the four-way adjustable mounting device 30, ensuring that the mounting device is level is accomplished through a plurality of bubble levels 28. The levels 28 may be located at various points on the mounting device (FIG. 3). Bubble levels 28 are used as guidance to ensure that the mounting device 10, 30 is level during and after rotation of the plurality of adjustable threaded rods 24 and prior to mounting the tree stand 100 to the mounting device.

After the chosen tree stand mounting device 10, 30 is secured and leveled in an appropriate tree 50, the mounting device is ready to receive a tree stand 100 (FIG. 10). Initially, the tree stand 100 can be attached to an upper bar 104 on the top of the center section 12 using a carabiner. While the tree stand 100 is hanging on the upper bar 104, a plurality of straps 108 can be secured around the tree stand 100 and the trunk of a tree 50 prior to positioning the tree stand on the mounting device 10, 30. Notches or prongs (not shown) on the tree stand 100 engage the top pad 15 and bottom pad 16 respectively, further securing the tree stand into position on the mounting device 10, 30.

It should be noted that various changes and modifications to the presently preferred embodiments described herein will be apparent to those skilled in the art. Such changes and modifications may be made without departing from the spirit and scope of the present disclosure and without diminishing its attendant advantages. Further, references throughout the specification to “the invention” are nonlimiting, and it should be noted that claim limitations presented herein are not meant to describe the invention as a whole. Moreover, the disclosure illustratively disclosed herein suitably may be practiced in the absence of any element which is not specifically disclosed herein.

1. A tree stand mounting device comprising:
a body having center section, the center section having a first end and a second opposing end; and,
a plurality of adjustment mechanisms each adjustment mechanism positioned at a separate location along the body of the mounting device, wherein each adjustment mechanism is configured to level the tree stand mounting device in relation to a mounting surface.

2. The tree stand mounting device of claim 1, wherein a first support pad is positioned on the first end of the center section.

3. The tree stand mounting device of claim 2, wherein a first adjustment mechanism and a second adjustment mechanism are positioned on or near the first support pad.

4. The tree stand mounting device of claim 3, wherein the second adjustment mechanism is positioned opposing to the first adjustment mechanism.

4. The tree stand mounting device of claim 1, wherein a second support pad is positioned on the second end of the center section.

5. The tree stand mounting device of claim 4, wherein a third adjustment mechanism and a fourth adjustment mechanism are positioned on or near the second support pad.

6. The tree stand mounting device of claim 5, wherein the fourth adjustment mechanism is positioned opposing to the third adjustment mechanism.

7. The tree stand mounting device of claim 1, wherein each adjustment mechanism is configured for independent movement from each other.

8. The tree stand mounting device of claim 1, wherein each adjustment mechanism comprises a threaded rod having a handle.

9. The tree stand mounting device of claim 8, wherein the capable of forward and backward movement in relation to the body of the device.

10. The tree stand mounting device of claim 8, wherein the capable of forward and backward movement and side-to-side movement in relation to the body of the device.

11. A tree stand mounting and leveling device comprising:
a body having center section with a first end and a second opposing end;
a first adjustment mechanism positioned near the first end;
a second adjustment mechanism positioned near the first end and opposing the first adjustment mechanism;
a third adjustment mechanism positioned near the second end;
a fourth adjustment mechanism positioned near the second end and opposing the third adjustment mechanism;
wherein each adjustment mechanism is independently moveable and configured for securing and leveling the body to a mounting structure.

12. The tree stand mounting and leveling device of claim 11, wherein each adjustment mechanism comprises a threaded rod and handle.

13. The tree stand mounting and leveling device of claim 12, wherein the threaded rod is capable of forward and backward movement in relation to the body of the device.

14. The tree stand mounting and leveling device of claim 13, wherein the movement of the threaded rod and the forward and backward movement of the body aligns the body with a mounting structure.

15. The tree stand mounting and leveling device of claim 11, wherein the body is capable of side-to-side movement in relation to the mounting structure.

17. The tree stand mounting and leveling device of claim 12, wherein the threaded rod is capable of securing the body to the mounting structure.

18. A method of mounting a tree stand to a surface of a tree, the method comprising the steps of:
providing a tree stand mounting device comprising:
a body having center section, the center section having a first end and a second opposing end; and,
a plurality of adjustment mechanisms each adjustment mechanism positioned at a separate location along the body of the mounting device;
securing the tree stand mounting device to the surface of the tree;
adjusting the plurality of adjustment mechanism to align the body with the surface of the tree;
leveling the body of the tree stand mounting device relative to the surface of the tree; and
securing the tree stand to the tree stand mounting device.

19. The method of claim 18, wherein the step of adjusting the plurality of adjustment mechanism includes adjusting each adjustment mechanism individually to align the body with the surface of the tree.

20. The method of claim 19, wherein the step of leveling the body of the tree stand mounting device includes moving the body in multiple positions including forward, backward and side-to-side in relation to the surface of the tree.
